(19) United States
(12) Patent Application Publication
(10) Pub. No.: US 2018/0068502 A1
(43) Pub. Date: Mar. 8, 2018

(54) METHOD AND DEVICE FOR PROVIDING AN ITEM OF INFORMATION REGARDING A PASSENGER PROTECTION SYSTEM OF A VEHICLE USING A MOBILE USER TERMINAL

(71) Applicant: Robert Bosch GmbH, Stuttgart (DE)

(72) Inventors: Florian Oesterle, Stuttgart (DE); Gian Antonio D' Addetta, Stuttgart (DE); Heiko Freienstein, Weil Der Stadt (DE)

(21) Appl. No.: 15/662,519

(22) Filed: Jul. 28, 2017

(30) Foreign Application Priority Data
Sep. 7, 2016 (DE) 102016216980.7

(51) Int. Cl. G07C 5/08; H04N 7/18; G07C 5/00

(52) U.S. Cl. CPC G07C 5/0866; G07C 5/008; H04N 7/185

(57) ABSTRACT

A method for providing an item of information regarding a passenger protection system of a vehicle using a mobile user terminal. In the process, an image signal that represents at least one image of at least one vehicle section of the vehicle is read in to begin with. In a further step, the image signal is processed in order to allocate at least one component of the passenger protection system to the vehicle section. Finally, a display signal for the display of an item of information representing the component is generated on the mobile user terminal.

### CROSS REFERENCE

The present application claims the benefit under 35 U.S.C. §119 of German Patent Application No. DE 102016216980.7 filed on Sep. 7, 2016, which is expressly incorporated herein by reference in its entirety.

### BACKGROUND INFORMATION

The present invention relates to a device, a method, and a computer program.

Modern vehicles may be equipped with a display for the graphical interaction with a vehicle passenger.

### SUMMARY

In accordance with the present invention, a method, a device, and a corresponding computer program are provided for providing an item of information regarding a passenger protection system of a vehicle using a mobile user terminal. Advantageous developments and improvement of the present invention are described herein.

In accordance with an embodiment of the present invention, a method is provided for providing an item of information regarding a personal protection system of a vehicle utilizing a mobile user terminal, the method including the following steps:

Reading in an image signal, which represents at least one image of at least one vehicle section of the vehicle;

Processing the image signal in order to allocate at least one component of the passenger protection system to the vehicle section; and

Generating a display signal for displaying an item of information that represents the component on the mobile user terminal.

An item of information may describe a visual item of information, in particular. For example, the item of information may involve an image, an image sequence or a sequence of letters or numbers. The item of information may optionally also include a tone signal. The passenger protection system, for example, may encompass a restraint device such as an airbag or a belt tightener, or a driver assistance system for assisting a driver of the vehicle through automatic interventions in a steering or braking behavior of the vehicle. The component, for instance, may be an airbag or a pressure sensor, an acceleration or locating sensor, GPS, a video, radar, wheel-pressure, wheel-speed or a steering angle sensor or a camera. A mobile user terminal, for instance, may be understood as a mobile telephone, in particular a smartphone, a laptop, a tablet PC, a smart watch or data glasses. The mobile user terminal may be developed to display the item of information on a display unit of the mobile user terminal, using the display signal. Optionally, the mobile user terminal may include an interface for the communication with a control unit of the vehicle. It is also conceivable that the mobile user terminal “wakes up” the sensor in order to obtain an item of information, e.g., in case the sensors are not energized, etc.

Depending on the specific embodiment, the method may be at least partially executed by the mobile user terminal itself or by a device that is integrated into the vehicle.

In accordance with the present invention, a component of a passenger protection system of a vehicle, e.g., in the form of a holistically acting, integrated safety concept, is able to be visualized on a mobile user terminal for instance by a schematic overlaying of a camera image of the vehicle. In so doing, the component may be displayed in real time on a smartphone, a tablet or data glasses, for example, while a user of the mobile user terminal is present inside or outside the vehicle. For instance, the component, or an item of information representing the component, may be displayed on the mobile user terminal using a suitable augmented-reality application. This makes it possible, for example, to visualize all components of the passenger protection system via an augmented-reality interface on the mobile user terminal and to thereby make these components more familiar to the user in a clear and comprehensible manner.

According to a specific embodiment, in the step of generating, the display signal may be generated for the purpose of overlaying the item of information on an image displayed on the mobile user terminal. The information is thereby able to be embedded in the image shown on the mobile user terminal in an optically appealing manner.

According to a further specific embodiment, using the image signal, an additional display signal for displaying the image of the vehicle section on the mobile user terminal is able to be generated in the step of generating. This makes it possible to display the vehicle section on the mobile user terminal.

It is advantageous if the display signal and the further display signal are generated in the step of generating in order to display the overlaying of the image of the vehicle section with the information on the mobile user terminal. For example, this makes it possible to display the component on the mobile user terminal in a manner that corresponds to its actual position on the vehicle section.

Moreover, in the step of generating, the display signal may be generated in order to display at least one image of the component as the item of information. This makes it easy to illustrate the component to a user of the mobile user terminal.

According to another specific embodiment, in the step of processing, the image signal may be processed in order to also ascertain a position and, additionally or alternatively, a location of the component relative to the mobile user terminal. In the process, the display signal is able to be generated as a function of the position and/or the location in the step of generating. This allows for a realistic representation of the component on the mobile user terminal. For example, the component is thereby able to be displayed on the mobile user terminal in real time.

Furthermore, in the step of reading in, an input signal that represents an input by a user of the mobile user terminal may be read in. In the step of generating, an item of status information representing a status of the component is able to be generated for display on the mobile user terminal. In addition or as an alternative, in the step of generating the input signal may be used to generate a control signal for controlling the vehicle. For example, the control signal is able to be output via a suitable interface to a control unit of the vehicle, such as by way of a CAN bus. A status, for example, may describe an operating state or a technical parameter of the component. The control signal is able to be used to control a motor-operated component of the vehicle, for instance. This specific embodiment allows the user of the mobile user terminal to control the display of the information. In addition, this specific embodiment makes it possible to control the vehicle via a user input.

According to another specific embodiment, in the step of reading in, a vehicle signal is able to be read in via an interface to a control unit of the vehicle. In the step of generating, the display signal may furthermore be generated with the aid of the vehicle signal; a vehicle signal, for example, describes a signal that is output via the CAN bus of the vehicle. The vehicle signal may represent the content of an error memory of the vehicle, for instance. It is also conceivable to use a read-out error code as a vehicle signal, as well as its allocation to a component/system including an item of information via a visual display indicating the location of the error. This specific embodiment allows the vehicle to control the display of the information.

According to another specific embodiment of the described approach, in the step of generating, the display signal may be generated in real time and/or with the aid of at least one item of information that corresponds to at least one parameter acquired by the component of the passenger protection system. This makes it possible to display the current status of the system to the user in a very rapid manner and/or, for instance, under consideration of parameters that were already acquired by the corresponding component, e.g., an environment sensor of the passenger protection system.

This method may be implemented in the form of software or hardware, for instance, or in a mixed form of software and hardware, for example in a control unit.

Moreover, the present invention provides a device that is designed to carry out, activate or implement the steps of a variant of a method described herein in corresponding devices. This variant of an embodiment of the present invention in the form of a device likewise makes it possible to achieve the objective on which the present invention is based in a rapid and efficient manner.

For this purpose, the device may include at least one arithmetic unit for processing signals or data, at least one memory unit for storing signals or data, at least one interface to a sensor or to an actuator for reading in sensor signals from the sensor or for outputting data or control signals to the actuator, and/or at least one communications interface for reading in or outputting data, which are embedded in a communications protocol. The arithmetic unit, for example, may be a signal processor, a microcontroller or the like, and the memory unit could be a flash memory, an EPROM, or a magnetic memory unit. The communications interface may be designed to read in or output data in a wireless and/or a wire-conducted manner; a communications interface that is able to read in or output wire-conducted data may read these data in electrically or optically, for example, from a corresponding data transmission line or may output it to a corresponding data transmission line.

In this context, a device may be understood to describe an electrical device which processes sensor signals and outputs control and/or data signals as a function of such processing. The device may include an interface developed in the form of hardware and/or software. In the case of a hardware development, the interfaces may be part of what is known as a system ASIC, for instance, which encompasses a wide variety of functions of the device. However, it is also possible for the interfaces to be discrete, integrated switching circuits or for the interfaces to be at least partially made up of discrete components. In the case of a development in the form of software, the interfaces may be software modules provided on a microcontroller in addition to other software modules.

For example, the device may be realized as part of the mobile user terminal. As already mentioned, the device may alternatively also be a component of the vehicle.

Also advantageous is a computer program product or a computer program having program code, which could be stored on a machine-readable carrier or memory medium such as a semiconductor memory, a hard disk memory or an optical memory, and which is used for executing, implementing and/or actuating the steps of the present method as recited in one of the afore-described specific embodiments, in particular when the program product or the program is running on a computer or a device. For instance, the computer program product may be an application that can be executed on the mobile user terminal.

Exemplary embodiments of the present invention are shown in the figures and described in greater detail below.

### BRIEF DESCRIPTION OF THE DRAWINGS

FIG. 1 shows a schematic illustration of a device according to an exemplary embodiment.

FIG. 2 shows a schematic illustration of a device from FIG. 1.

FIG. 3 shows a flow diagram of a method according to an exemplary embodiment.

### DETAILED DESCRIPTION OF EXAMPLE EMBODIMENTS

In the following description of advantageous exemplary embodiments of the present invention, identical or similar reference numerals are used for the various elements that act in a similar manner and are shown in the various figures, and a repeated description of these elements has been omitted.

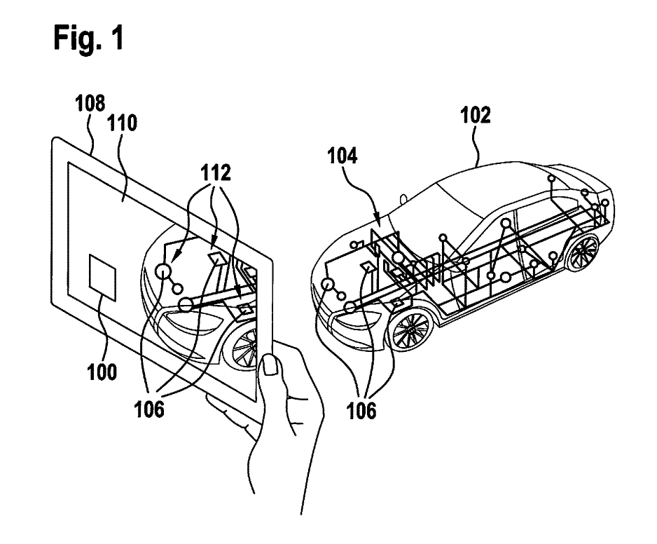

FIG. 1 shows a schematic illustration of a device 100 according to an exemplary embodiment. Also shown is a vehicle 102 provided with a passenger protection system 104, which includes a plurality of components 106 such as sensors or restraint means, as well as a mobile user terminal 108, which in this particular case is a tablet PC including a screen 110. According to this exemplary embodiment, device 100 is realized as a component of mobile user terminal 108. Mobile user terminal 108 is designed to record an image of a vehicle section of vehicle 102, and device 100 is designed to process the image. In so doing, device 100 allocates at least one of components 106 to the image of the vehicle section recorded by mobile user terminal 108. For example, the particular components 106 that are located in said vehicle section are allocated to the vehicle section by device 100. In addition, device 100 is designed to display an item of information 112 with regard to components 106 allocated to the vehicle section via screen 110.

According to the exemplary embodiment shown in FIG. 1, item of information 112 involves images of components 106 and also corresponding status reports such as “radar: active” or “PAS: active”. For one, the image of the vehicle section itself is shown on screen 110 with the aid of device 100. For another, the image of the vehicle section is overlaid with images of components 106 allocated to the vehicle section, in such a way that the respective positions of components 106 displayed on screen 110 relative to the vehicle section shown on screen 110 correspond to the actual positions of components 106 in vehicle 102. Also conceivable here is the reading out of error codes (not shown in FIG. 1) of the corresponding component(s) of passenger protection system 104 so that errors possibly identified by this time are already able to be graphically displayed at this stage. An exemplary representation of a component view realized with the aid of device 100 is shown in FIG. 1. Depending on the vehicle section, all integral safety components of passenger protection system 104 are displayable on mobile user terminal 108.

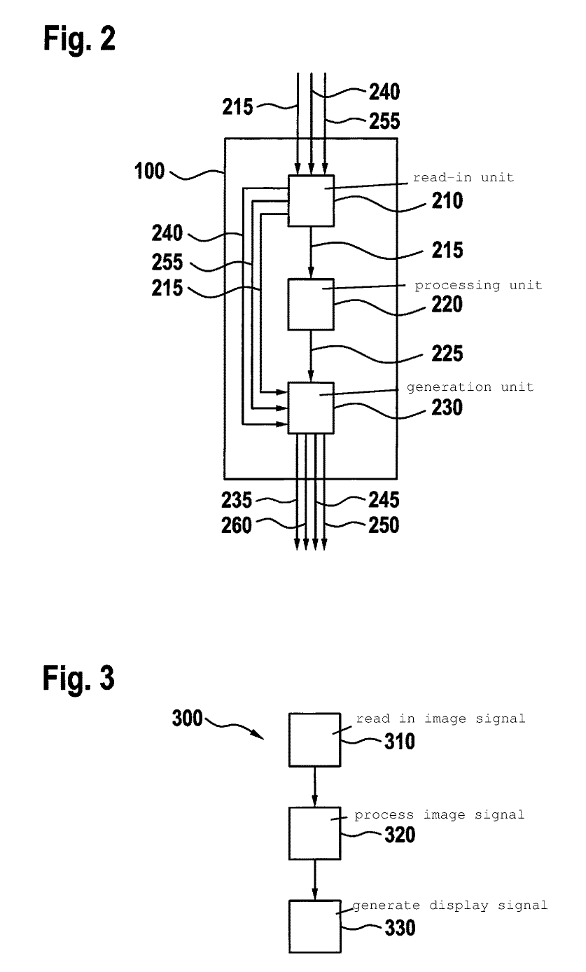

FIG. 2 shows a schematic representation of a device 100 from FIG. 1. Device 100 includes a read-in unit 210 for reading in an image signal 215 that was generated by a camera of the mobile user terminal, for example, and that represents the image of the vehicle section. Read-in unit 210 transmits image signal 215 to a processing unit 220, which is designed to allocate at least one component of the passenger protection system to the vehicle section represented by image signal 215, utilizing image signal 215. Processing unit 220 generates an allocation signal 225 as the result of the processing. A generation unit 230 of device 100 is designed to receive allocation signal 225 from processing unit 220 and to generate a display signal 235 for the display of an item of information that represents the component on the mobile user terminal with the aid of processing signal 225. For example, generation unit 230 outputs display signal 235 to an interface to the screen of the mobile user terminal in order to display the information on the screen. Depending on the exemplary embodiment, display signal 235, for example, represents an image of the component allocated to the vehicle section or it represents some other visual item of information such as a text or number sequence with regard to the component.

According to an exemplary embodiment, in addition to reading in image signal 215, read-in unit 210 is designed to read in an optional input signal 240, which represents an input made by a user of the mobile user terminal, and to forward it to generation unit 230. Generation unit 230 is designed to use input signal 240 to generate an item of status information 245 pertaining to a status of the component. Item of status information 245, for example, is able to be displayed via the screen of the mobile user terminal, analogous to the item of information represented by display signal 235. Optionally, generation unit 230 is designed to use input signal 240 to generate a control signal 250 for controlling the vehicle and to output it to a suitable interface to a control unit of the vehicle.

Read-in unit 210 may optionally be designed to read in a vehicle signal 255 via the interface to the control unit of the vehicle and to forward it to generation unit 230. In this case, generation unit 230 may be designed to generate display signal 235 with the aid of vehicle signal 255.

According to a further exemplary embodiment, generation unit 230 is designed to generate an optional additional display signal 260 using image signal 215; for example, this additional display signal 260 may be used for displaying the image of the vehicle section recorded by the camera of the mobile user terminal on the screen of the mobile user terminal. In so doing, the information representing the component and the image of the vehicle section may be overlaid with each other.

FIG. 3 shows a flow diagram of a method 300 according to an exemplary embodiment. Method 300 for providing an item of information regarding a passenger protection system of a vehicle with the aid of a mobile user terminal may be carried out by a device as previously described with the aid of FIGS. 1 and 2, for example. The image signal representing the image of the vehicle section is read in in a step 310. In a further step 320, the image signal is processed, and at least one component of the passenger protection system is allocated to the vehicle section in the process. Depending on a result of the processing, a display signal for the display of an item of information representing the component will finally be generated in a step 330.

Steps 310, 320, 330 may be carried out on a continuous basis.

In addition to components of the passenger protection device, it is also possible to visualize components of a drive train of the vehicle, for example.

Generally, a user experience in connection with systems of passive safety, such as for an airbag and airbag control unit, is limited to a warning lamp on an instrument panel that goes off after the ignition is switched on if properly functioning, and to various labels in the vehicle interior. Within the framework of current integrated safety, in a first stage for the more robust triggering of safety systems, it is additionally possible to use signals from an active safety system and from an environment sensor system, predominantly from the batch of assistance and active safety systems, for detecting a potential collision. A resulting possible actuation of a reversible belt tightener in the phase preceding the collision or during highly dynamic driving maneuvers such as during skidding or off-road driving, may likewise be considered a starting point for enhancing the user experience for the driver and other passengers.

For example, different sensors such as radar, ultrasonic or video sensors, may be used for driver-assistance and safety-relevant functions for the purpose of detecting the vehicle environment. The objective is the acquisition of information pertaining to the environment, such as critical objects on a collision course, that are relevant for the respective function. Of increasing importance, in particular, is the optimal conditioning of less than ideal sensor signals for a reliable detection and classification of objects in the environment of the vehicle.

At an interface of active and passive safety, so-called pre-crash functions may utilize the sensors of active safety for detecting the environment so that, in a critical situation, a potential collision is detected already prior to contact with a relevant object. If a collision is unavoidable, the activation thresholds on the airbag control unit, for one, may be lowered in an effort to optimize the reliability and robustness of the triggering decision of restraint systems. In addition, reversible pre-firing functions, e.g., for actuating a reversible seat belt tightener driven by an electric motor, or even irreversible restraint means of passive safety, also known as pre-trigger functions, such as for the actuation of various airbags or adaptive crash structures, for instance, may be activated in an effort to mitigate the consequences of an accident for the vehicle passengers. In the case of an unavoidable collision, a collision type or collision severity is able to be influenced in a positive manner through evasive maneuvers or braking interventions in order to thereby protect the passengers in an optimal manner with the aid of the available restraint means.

Integrated safety systems revisit the possibilities of the currently still independently acting safety and comfort systems and exploit the optimal synergy effects through potential networking of the systems.

The use of expanded reality techniques, also known as augmented reality, is available in the art. For example, augmented reality applications are able to selectively supply supplementary information, such as in a computer-assisted manner. To do so, three-dimensional objects, explanatory texts, images or videos may be faded into a real environment, for example on a tablet computer or a smartphone, as soon as the user points the device camera at an area for which supplementary information is available.

In contrast, one of the goals of the approach presented here is a visualization of all components of a holistically acting, integrated safety concept that are not directly visible by way of an augmented reality interface. For example, the visualization of the components in real time is able to be generated in the form of a schematic overlay of a camera image (as augmented reality) on a smartphone, a tablet or on data glasses, while the user with the respective device is present inside or outside of the vehicle. The user may download a corresponding application, for example, and use it to generate such a visualization. For instance, the visualization is able to inform about the presence and operativeness of the numerous systems in an uncomplicated manner. However, it is also conceivable to realize an opportunity for experiencing all of the systems and components used or involved in protecting passengers in a holistic manner.

For instance, the user has the option of displaying all components of the integral, i.e., passive and active, safety systems as augmented reality on a current video image. The orientation of the mobile user terminal relative to the vehicle section is determined with the aid of image recognition of the vehicle section, for example, and an orientation is calculated therefrom.

Another option consists of the user initiating a status query of the components, e.g., by touching corresponding augmented-reality graphics. The subject matter of the status query, for one, could relate to general technical details of the safety components, such as details of otherwise hidden components of active and passive safety, e.g., airbags, peripheral pressure or acceleration sensors, radar sensors, wheel-pressure sensors, wheel-speed sensors or steering-angle sensors, for example. For another, such a status query may involve the contribution a particular component has made to the vehicle safety up to that point, e.g., since the last refueling stop, since the start of driving, since the production of the vehicle.

In addition, a demand for new safety components that are available in new models with rising innovation progress may be generated by updating applications and grayed-out systems. For example, ageing of the vehicle system is able to be demonstrated, thereby creating interest in a vehicle replacement. Practical retrofitting solutions such as ultrasonic parking sensors or radar sensors may be pointed out as an alternative.

According to an alternative exemplary embodiment, in addition to the pure visualization of safety systems, it is also possible to illustrate their function, using function sketches, small animations or videos, for example.

An actuation of the systems in real time is possible as well. In this case, a current environment may also be displayed when the vehicle is at a standstill, for example. A view of the vehicle or of additional vehicles from the bird's eye perspective is able to be generated in the process. This makes it possible to show many of the sensors allocated to the driver assistance during their operation. In a similar manner, motor-operated components such as an electromotive retractor are able to be activated in passive safety systems and activated at a lower power in a demo mode. A real-time demo mode requires an energization of the respective sensors and of the processing control units.

According to a further exemplary embodiment, through a connection to the vehicle, such as via the CAN interface, a connection to the vehicle is able to be established in order to read out an error memory of the vehicle and to visually display the error on the vehicle.

If an exemplary embodiment includes an “and/or” linkage between a first feature and a second feature, then this should be read in such a way that the exemplary embodiment according to one specific embodiment includes both the first feature and the second feature, and according to an additional specific embodiment, the exemplary embodiment includes either only the first feature or only the second feature.

What is claimed is:

1. A method for providing an item of information regarding a passenger protection system of a vehicle using a mobile user terminal, the method comprising:
reading in an image signal which represents at least one image of at least one vehicle section of the vehicle;
processing the image signal to allocate at least one component of the passenger protection system to the vehicle section; and
generating a display signal for displaying an item of information representing the component on the mobile user terminal.

2. The method as recited in claim 1, wherein in the generating step, the display signal is generated to overlay an image displayed on the mobile user terminal with the item of information.

3. The method as recited in claim 1, wherein in the generating step, using the image signal, an additional display signal is generated for displaying the image of the vehicle section on the mobile user terminal.

4. The method as recited in claim 3, wherein in the generating step, the display signal and the additional display signal are generated to display an overlaying of the image of the vehicle with the item of information on the mobile user terminal.

5. The method as recited in claim 1, wherein in the generating step, the display signal is generated to display at least one image of the component as the item of information.

6. The method as recited in claim 1, wherein in the processing step, the image signal is processed to also ascertain at least one of a position of the component and a location of the component relative to the mobile user terminal, and in the generating step, the display signal is generated as a function of the at least one of the position and the location.

7. The method as recited in claim 1, wherein in the reading in step, an input signal representing an input of a user of the mobile user terminal is read in, and in the generating step, using the input signal, at least one of: (i) an item of status information representing a status of the component is generated for the display on the mobile user terminal, and (ii) a control signal is generated for controlling the vehicle.

8. The method as recited in claim 1, wherein in the reading in step, a vehicle signal is read in via an interface to a control unit of the vehicle, and in the generating step, the display signal is generated using the vehicle signal.

9. The method as recited in claim 1, wherein in the generating step, the display signal is generated at least one of: (i) in real time, and (ii) using information that corresponds to at least one parameter acquired by the component of the passenger protection system.

10. A device for providing an item of information regarding a passenger protection system of a vehicle using a mobile user terminal, the device designed to:
read in an image signal which represents at least one image of at least one vehicle section of the vehicle;
process the image signal to allocate at least one component of the passenger protection system to the vehicle section; and
generate a display signal for displaying an item of information representing the component on the mobile user terminal.

11. A non-transitory machine-readable memory medium on which is stored a computer program for providing an item of information regarding a passenger protection system of a vehicle using a mobile user terminal, the computer program, when executed by a processor, causing the processor to perform:
reading in an image signal which represents at least one image of at least one vehicle section of the vehicle;
processing the image signal to allocate at least one component of the passenger protection system to the vehicle section; and
generating a display signal for displaying an item of information representing the component on the mobile user terminal.
